(19) United States
(12) Patent Application Publication
(10) Pub. No.: US 2007/0098067 A1
(43) Pub. Date: May 3, 2007

(54) Method and apparatus for video encoding/decoding

(75) Inventors: So-young Kim, Yongin-si (KR); Jeong-hoon Park, Seoul (KR); Sang-rae Lee, Suwon-si (KR); Jae-chool Lee, Suwon-si (KR); Yu-mi Sohn, Seongnam-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/591,607

(22) Filed: Nov. 2, 2006

(30) Foreign Application Priority Data
Nov. 2, 2005 (KR) 10-2005-0104361

(51) Int. Cl. H04N 7/12; H04N 11/04

(52) U.S. Cl. 375/240.08; 375/240.24

(57) ABSTRACT

A method and apparatus for video encoding/decoding are provided to improve compression efficiency by generating a prediction block using an intra-inter hybrid predictor. A video encoding method includes dividing an input video into a plurality of blocks, forming a first predictor for an edge region of a current block to be encoded among the divided blocks through intraprediction, forming a second predictor for the remaining region of the current block through interprediction, and forming a prediction block of the current block by combining the first predictor and the second predictor.

### CROSS-REFERENCE TO RELATED PATENT APPLICATION

This application claims priority from Korean Patent Application No. 10-2005-0104361, filed on Nov. 2, 2005, in the Korean Intellectual Property Office, the disclosure of which is incorporated herein in its entirety by reference.

### BACKGROUND OF THE INVENTION

1. Field of the Invention

Methods and apparatuses consistent with the present invention relates to video compression encoding/decoding, and more particularly, to video encoding/decoding which can improve compression efficiency by generating a prediction block using an intra-inter hybrid predictor.

2. Description of the Related Art

In video compression standards such as Moving Picture Experts Group (MPEG)-1, MPEG-2, MPEG-4 Visual, H.261, H.263, and H.264, a frame is generally divided into a plurality of macroblocks. Next, a prediction process is performed on each of the macroblocks to obtain a prediction block and a difference between the original block and the prediction block is transformed and quantized for video compression.

There are two types of prediction, i.e., intraprediction and interprediction. In intraprediction, a current block is predicted using data of neighboring blocks of the current block in a current frame, which have already been encoded and reconstructed. In interprediction, a prediction block of the current block is generated from at least one reference frames using block-based motion compensation.

FIG. 1 illustrates 4×4 intraprediction modes according to the H.264 standard.

Referring to FIG. 1, there are nine 4×4 intraprediction modes, i.e. a vertical mode, a horizontal mode, a direct current (DC) mode, a diagonal down-left mode, a diagonal down-right mode, a vertical right mode, a vertical left mode, a horizontal up mode, and a horizontal down mode. Pixel values of a current block are predicted using pixel values of pixels A through M of neighboring blocks of the current block according to the 4×4 intraprediction modes.

In the case of interprediction, motion compensation/motion estimation are performed on the current block by referring to a reference picture such as a previous and/or a next picture and the prediction block of the current block is generated.

A residue between the prediction block generated according to an intraprediction mode or an interprediction mode and the original block undergoes discrete cosine transform (DCT), quantization, and variable-length coding for video compression encoding.

In this way, according to the prior art, the prediction block of the current block is generated according to an intraprediction mode or an interprediction mode, a cost is calculated using a predetermined cost function, and a mode having the smallest cost is selected for video encoding, thereby improving compression efficiency.

However, there is still a need for a video encoding method having improved compression efficiency to overcome a limited transmission bandwidth and provide high-quality video to users.

### SUMMARY OF THE INVENTION

Exemplary embodiments of the present invention overcome the above disadvantages and other disadvantages not described above. Also, the present invention is not required to overcome the disadvantages described above, and an exemplary embodiment of the present invention may not overcome any of the problems described above.

The present invention provides a video encoding method and apparatus can improve compression efficiency in video encoding.

The present invention also provides a video decoding method and apparatus can efficiently decode video data that is encoded using the video encoding method according to the present invention.

According to one aspect of the present invention, there is provided a video encoding method including dividing an input video into a plurality of blocks, forming a first predictor for an edge region of a current block to be encoded among the divided blocks through intraprediction, forming a second predictor for the remaining region of the current block through interprediction, and forming a prediction block of the current block by combining the first predictor and the second predictor.

According to another aspect of the present invention, there is provided a video encoder including a hybrid prediction unit which forms a first predictor for an edge region of a current block to be encoded among a plurality of blocks divided from an input video through intraprediction, forms a second predictor for the remaining region of the current block through interprediction, and forms a prediction block of the current block by combining the first predictor and the second predictor.

According to still another aspect of the present invention, there is provided a video decoding method including determining a prediction mode of a current block to be decoded based on prediction mode information included in a received bitstream, if the determined prediction mode is a hybrid prediction mode in which an edge region of the current block is predicted using intraprediction and the remaining region of the current block is predicted using interprediction, forming a first predictor for the boundary region of the current block through intraprediction, forming a second predictor for the remaining region of the current block through interprediction, and forming a prediction block of the current block by combining the first predictor and the second predictor, and decoding a video by adding a residue included in the bitstream to the prediction block.

According to yet another aspect of the present invention, there is provided a video decoder including a hybrid prediction unit, which, if prediction mode information extracted from a received bitstream indicates a hybrid prediction mode in which an edge region of the current block is predicted using intraprediction and the remaining region of the current block is predicted using interprediction, forms a first predictor for the boundary region of the current block through intraprediction, forms a second predictor for the remaining region of the current block through interprediction, and forms a prediction block of the current block by combining the first predictor and the second predictor.

### BRIEF DESCRIPTION OF THE DRAWINGS

The above and other features and advantages of the present invention will become more apparent by describing in detail exemplary embodiments thereof with reference to the attached drawings in which:

FIG. 1 illustrates 4×4 intraprediction modes according to the H.264 standard;

FIG. 2 is a block diagram of a video encoder according to an exemplary embodiment of the present invention;

FIGS. 3A through 3C illustrate hybrid predictors according to an exemplary embodiment of the present invention;

FIG. 4 is a view for explaining the operation of a hybrid prediction unit according to an exemplary embodiment of the present invention;

FIG. 5 illustrates a hybrid prediction block predicted using hybrid prediction according to an exemplary embodiment of the present invention;

FIG. 6 is a flowchart illustrating a video encoding method according to an exemplary embodiment of the present invention;

FIG. 7 is a block diagram of a video decoder according to an exemplary embodiment of the present invention; and

FIG. 8 is a flowchart illustrating a video decoding method according to an exemplary embodiment of the present invention.

### DETAILED DESCRIPTION OF EXEMPLARY EMBODIMENT OF THE INVENTION

Hereinafter, exemplary embodiments of the present invention will be described in detail with reference to the accompanying drawings.

A video encoding method and apparatus according to the present invention forms a first predictor for the edge region of a current block through intraprediction using sample values of neighboring blocks of the current block, forms a second predictor for the remaining region of the current block through interprediction using a reference picture, and combining the first predictor and the second predictor, thereby forming a prediction block of the current block. Since the edge region of a block generally has high correlation with neighboring blocks of the block, intraprediction is performed on the edge region of the current block using spatial correlation with the neighboring blocks and interprediction is performed on pixel values of the remaining region of the current block using temporal correlation with a block of a reference picture. In addition, interprediction is suitable for prediction of a shape and intraprediction is suitable for prediction of brightness. Thus, the prediction block of the current block is formed using hybrid prediction combining intraprediction and interprediction, thereby allowing more accurate prediction, reducing an error between the current block and the prediction block, and thus improving compression efficiency.

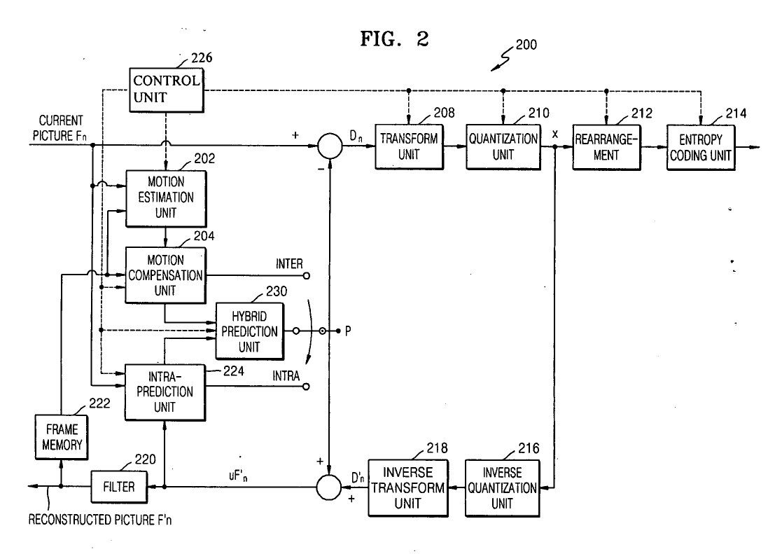

FIG. 2 is a block diagram of a video encoder 200 according to an exemplary embodiment of the present invention.

The video encoder 200 forms a prediction block of a current block to be encoded through interprediction, intraprediction, and hybrid prediction, determines a prediction mode having the smallest cost to be the final prediction mode, and performs transform, quantization, and entropy coding on a residue between the prediction block and the current block according to the determined prediction mode, thereby performing video compression. The interprediction and the intraprediction may be conventional interprediction and intraprediction, e.g., interprediction and intraprediction according to the H.264 standard.

Referring to FIG. 2, the video encoder 200 includes a motion estimation unit 202, a motion compensation unit 204, an intraprediction unit 224, a transform unit 208, a quantization unit 210, a rearrangement unit 212, an entropy coding unit 214, an inverse quantization unit 216, an inverse transform unit 218, a filter 220, a frame memory 222, a control unit 226, and a hybrid prediction unit 230.

For interprediction, the motion estimation unit 202 searches in a reference picture for a prediction value of a macroblock of the current picture. When a reference block is found in units of ½ pixels or ¼ pixels, the motion compensation unit 204 calculates the median pixel value of the reference block to determine reference block data. Interprediction is performed in this way by the motion estimation unit 202 and the motion compensation unit 204, thereby forming an interprediction block of the current block.

The intraprediction unit 224 searches in the current picture for a prediction value of a macroblock of the current picture for intraprediction, thereby forming an intraprediction block of the current block.

In particular, the video encoder 200 includes the hybrid prediction unit 230 that forms the prediction block of the current block through hybrid prediction combining interprediction and intraprediction.

The hybrid prediction unit 230 forms a first predictor for the edge region of the current block through intraprediction, forms a second predictor for the remaining region of the current block through interprediction, and combines the first predictor and the second predictor, thereby forming the prediction block of the current block.

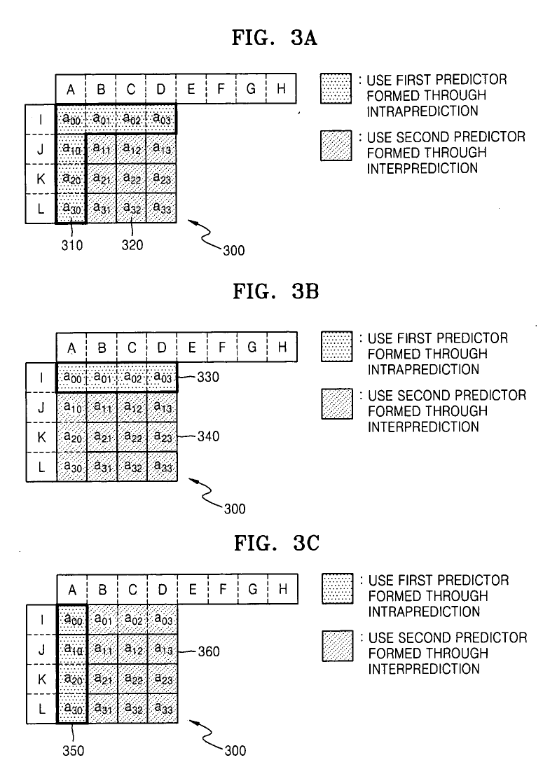

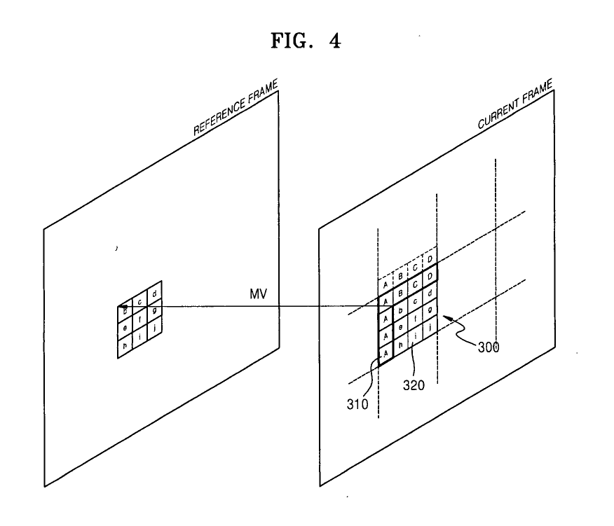

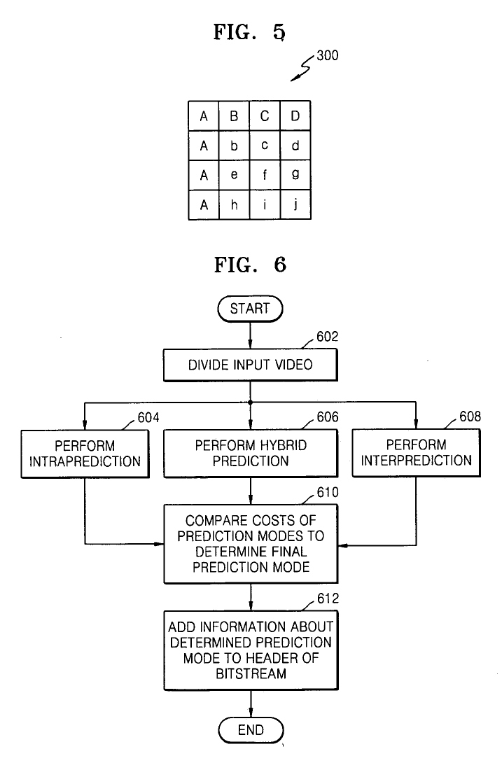

FIGS. 3A through 3C illustrate hybrid predictors according to an exemplary embodiment of the present invention, and FIG. 4 is a view for explaining the operation of the hybrid prediction unit 230 according to an exemplary embodiment of the present invention. Although a hybrid prediction block of a 4×4 current block 300 is generated in FIGS. 3A through 3C, a hybrid prediction block can be generated for blocks of various sizes. Hereinafter, it is assumed that a hybrid prediction block is generated for a 4×4 current block for convenience of explanation.

Referring to FIG. 3A, the hybrid prediction unit 230 forms a first predictor for pixels of an edge region 310 of the current block 300 through intraprediction using pixel values of neighboring blocks of the current block 300 and forms a second predictor for pixels of an internal region 320 of the current block 300 except for the edge region 310 through interprediction. It may be preferable that pixels of the edge region 310 be adjacent to a block that has already been processed for intraprediction. Although the edge region 310 has a width of one pixel in FIG. 3A, the width of the edge region 310 may vary.

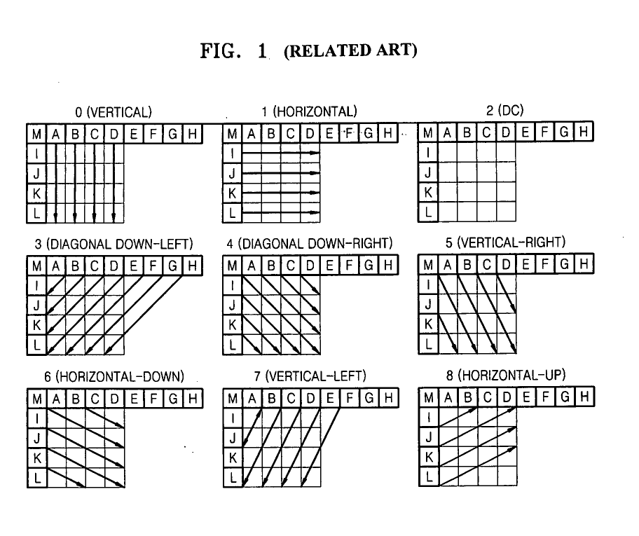

The hybrid prediction unit 230 may predict pixels of the edge region 310 according to various intraprediction modes available. In other words, pixels a00, a01, a02, a03, a10, a20, and a30 of the edge region 310 of the 4×4 current block 300 as illustrated in FIG. 3A may be predicted from pixels A through L of neighboring blocks of the current block 300, which are adjacent to the edge region 310, according to the 4×4 intraprediction modes illustrated in FIG. 1. The hybrid prediction unit 230 performs motion estimation and motion compensation on the internal region 320 of the current block 300 and predicts pixel values of pixels a11, a12, a13, a21, a22, a23, a31, a32, and a33 of the internal region 320 using a region of a reference frame, which is most similar to the internal region 320. The hybrid prediction unit 230 may also generate the hybrid prediction block using an interprediction result output from the motion compensation unit 204 and an intraprediction result output form the intraprediction unit 224.

For example, referring to FIG. 4, pixels of the edge region 310 are intrapredicted in a mode 0, i.e. the vertical mode among the 4×4 intraprediction modes according to the H.264 standard, illustrated in FIG. 1, and pixels of the internal region 320 are interpredicted from a region of a reference frame indicated by a predetermined motion vector MV through motion estimation and motion compensation.

FIG. 5 illustrates a hybrid prediction block predicted using hybrid prediction as illustrated in FIG. 4 according to an exemplary embodiment of the present invention. Referring to FIGS. 3A and 5, pixels of the edge region 310 are intrapredicted using their adjacent pixels of neighboring blocks of the current block and pixels of the internal region 320 are interpredicted from a region of a reference frame determined through motion estimation and motion compensation. In other words, the hybrid prediction unit 230 forms a first predictor for pixels of the edge region 310 through intraprediction

Similarly, referring to FIG. 3B, the hybrid prediction unit 230 forms a first predictor for pixels of an edge region 330 of the current block 300 through intraprediction using pixels of neighboring blocks of the current block 300 and forms a second predictor for pixels of an internal region 340 of the current block 300 through interprediction. Referring to FIG. 3C, the hybrid prediction unit 230 forms a first predictor for pixels of an edge region 350 of the current block 300 through intraprediction using pixels of neighboring blocks of the current block 300 and forms a second predictor for pixels of an internal region 360 of the current block 300 through interprediction.

The hybrid prediction unit 230 may form the prediction block of the current block by combining a weighted first predictor that is a product of the first predictor and a predetermined first weight w1 and a weighted second predictor that is a product of the second predictor and a predetermined second weight w2. The first weight w1 and the second weight w2 may be calculated using a ratio of the average of pixels of the first predictor formed through intraprediction and the average of pixels of the second predictor formed through interprediction. For example, when the average of the pixels of the first predictor is M1 and the average of the pixels of the second predictor is M2, the first weight w1 may be set to 1 and the second weight w2 may be set to M1/M2. This is because more accurate predictors can be formed using pixels formed through intraprediction, which reflect values of the current picture to be encoded.

In the case of the hybrid prediction block as illustrated in FIG. 5, the hybrid prediction unit 230 forms the weighted first predictor that is a product of the first predictor and the first weight w1 and the weighted second predictor that is a product of the second predictor and the second weight w2 and forms the prediction block by combining the weighted first predictor and the weighted second predictor.

The hybrid prediction unit 230 may use the pixels of the first predictor only for the purpose of adjusting the brightness of the interprediction block. In general, a difference between the brightness of the interprediction block and the brightness of its neighboring block may occur. To reduce the difference, the hybrid prediction unit 230 calculates a ratio of the average of the pixels of the first predictor and the average of the interpredicted pixels of the second predictor and forms the prediction block of the current block through interprediction while multiplying each of the pixels a00 through a33 of the interprediction block by a weight reflecting the calculated ratio. The intraprediction for calculation of the weight may be performed only on the first predictor or on the current block to be encoded.

Referring back to FIG. 2, the control unit 226 controls components of the video encoder 200 and selects the prediction mode that minimizes the difference between a prediction block and the original block among an interprediction mode, an intraprediction mode, or a hybrid prediction mode. More specifically, the controller 226 calculates the costs of an interprediction block, an intraprediction block, and a hybrid prediction block and determines a prediction mode that has the smallest cost to be the final prediction mode. Here, cost calculation may be performed using various methods such as a sum of absolute difference (SAD) cost function, a sum of absolute transformed difference (SATD) cost function, a sum of squares difference (SSD) cost function, a mean of absolute difference (MAD) cost function, and a Lagrange cost function. An SAD is a sum of absolute values of prediction residues of 4×4 blocks. An SATD is a sum of absolute values of coefficients obtained by applying a Hadamard transform to prediction residues of 4×4 blocks. An SSD is a sum of the squares of prediction residues of 4×4 block prediction samples. An MAD is an average of absolute values of prediction residues of 4×4 block prediction samples. The Lagrange cost function is a modified cost function including bitstream length information.

Once the prediction block to be referred to is found through interprediction, intraprediction, or hybrid prediction, it is extracted from the current block, transformed by the transform unit 208, and then quantized by the quantization unit 210. The portion of the current block remaining after subtracting the prediction block is referred to as a residue. In general, the residue is encoded to reduce the amount of data in video encoding. The quantized residue is processed by the rearrangement unit 212 and entropy-coded through context-based adaptive variable length coding (CAVLC) or context-adaptive binary arithmetic coding (CABAC) in the entropy coding unit 214.

To obtain a reference picture used for interprediction or hybrid prediction, a quantized picture is processed by the inverse quantization unit 216 and the inverse transform unit 218, and thus the current picture is reconstructed. The reconstructed current picture is processed by the filter 220 performing deblocking filtering, and is then stored in the frame memory 222 for use in interprediction or hybrid prediction of the next picture.

FIG. 6 is a flowchart illustrating a video encoding method according to an exemplary embodiment of the present invention.

Referring to FIG. 6, in operation 602, an input video is divided into predetermined-size blocks. For example, the input video may be divided into blocks of various sizes from 16×16 to 4×4.

In operation 604, a prediction block of a current block to be encoded is generated by performing intraprediction on the current block.

In operation 606, a prediction block of the current block is formed by performing hybrid prediction, i.e., by forming a first predictor for the edge region of the current block through intraprediction, forming a second predictor for the remaining region of the current block through interprediction, and combining the first predictor and the second predictor. As mentioned above, in the hybrid prediction, the prediction block may be formed by combining the weighted first predictor that is a product of the first predictor and the first weight w1 and the weighted second predictor that is a product of the second predictor and the second weight w2.

In operation 608, a prediction block of the current block is formed by performing interprediction on the current block. The order of operations 604 through 608 may be changed or operations 604 through 608 may be performed in parallel.

In operation 610, the costs of the prediction blocks formed through intraprediction, interprediction block, and hybrid prediction are calculated and the prediction mode having the smallest cost is determined to be the final prediction mode for the current block.

In operation 612, information about the determined final prediction mode is added to a header of an encoded bitstream to inform a video decoder that receives the bitstream which prediction mode has been used for encoding of video data included in the received bitstream.

The video encoding method according to the present invention can also be applied to an object-based video encoding method such as MPEG-4 in addition to a block-based video encoding method. In other words, the edge region of a current object to be encoded is predicted through intraprediction and the internal region of the object is predicted through interprediction to generate a prediction value that is more similar to the current object according to various prediction modes, thereby improving compression efficiency. When hybrid prediction according to the present invention is applied to the object-based video encoding method, it is necessary to divide objects included in a video and detect edges of the objects using an object segmentation or edge detection algorithm. The object segmentation or edge detection algorithm is well known and a description thereof will not be provided.

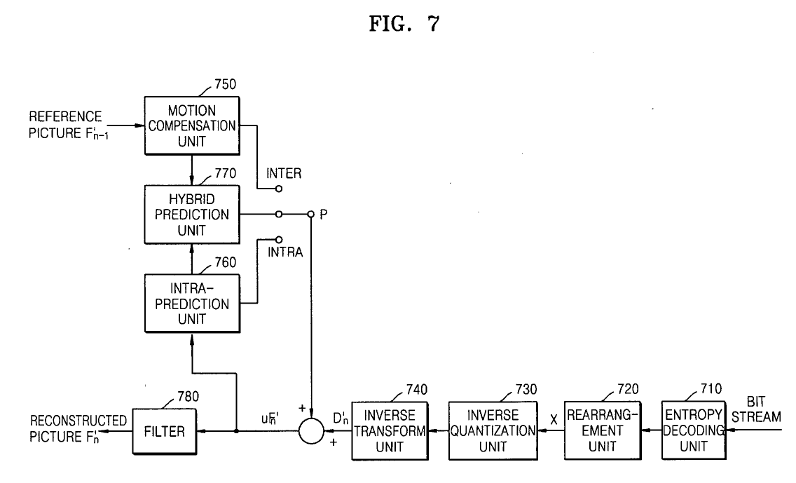

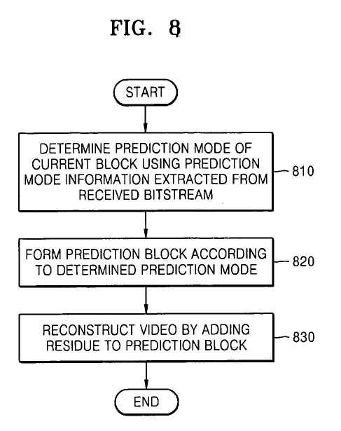

FIG. 7 is a block diagram of a video decoder according to an exemplary embodiment of the present invention.

Referring to FIG. 7, the video decoder includes an entropy-decoding unit 710, a rearrangement unit 720, an inverse quantization unit 730, an inverse transform unit 740, a motion compensation unit 750, an intraprediction unit 760, a hybrid prediction unit 770, and a filter 780. Here, the hybrid prediction unit 770 operates in the same manner as the hybrid prediction unit 230 of FIG. 2 in the generation of the hybrid prediction block.

The entropy-decoding unit 710 and the rearrangement unit 720 receive a compressed bitstream and perform entropy decoding, thereby generating a quantized coefficient. The inverse quantization unit 930 and the inverse transform unit 940 perform inverse quantization and inverse transform on the quantized coefficient, thereby extracting transform encoding coefficients, motion vector information, header information, and prediction mode information. The motion compensation unit 750, the intraprediction unit 760, and the hybrid prediction unit 770 determine a prediction mode used for encoding of a current video to be decoded from the prediction mode information included in a header of the bitstream and generate a prediction block of a current block to be decoded according to the determined prediction mode. The generated prediction block is added to a residue included in the bitstream, thereby reconstructing the video.

FIG. 8 is a flowchart illustrating a video decoding method according to an exemplary embodiment of the present invention.

In operation 810, a prediction mode used for encoding of a current block to be decoded is determined by parsing prediction mode information included in a header of a received bitstream.

In operation 820, a prediction block of the current block is generated using one of interprediction, intraprediction, and hybrid prediction according to the determined prediction mode. When the current block has been encoded through hybrid prediction, a first predictor is formed for the edge region of the current block through intraprediction, a second predictor is formed for the remaining region of the current block through interprediction, and the prediction block of the current block is generated by combining the first predictor and the second predictor.

In operation 830, the current block is reconstructed by adding a residue included in the bitstream to the generated prediction block and operations are repeated with respect to all blocks of a frame, thereby reconstructing the video.

As described above, according to the exemplary embodiments of the present invention, by adding a new prediction mode combining conventional interprediction and intraprediction, a prediction block that is more similar to a current block to be encoded can be generated according to video characteristics, thereby improving compression efficiency.

T present invention can also be embodied as computer-readable code on a computer-readable recording medium. The computer-readable recording medium is any data storage device that can store data which can be thereafter read by a computer system. Examples of the computer-readable recording medium include read-only memory (ROM), random-access memory (RAM), CD-ROMs, magnetic tapes, floppy disks, optical data storage devices, and carrier waves (e.g., transmission over the Internet). The computer-readable recording medium can also be distributed over network coupled computer systems so that the computer-readable code is stored and executed in a distributed fashion.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A video encoding method comprising:
dividing an input video into a plurality of blocks;
forming a first predictor for an edge region of a current block to be encoded among the divided blocks through intraprediction;
forming a second predictor for the remaining region of the current block through interprediction; and
forming a prediction block of the current block by combining the first predictor and the second predictor.

2. The video encoding method of claim 1, wherein the edge region of the current block includes pixels adjacent to previously encoded blocks.

3. The video encoding method of claim 1, wherein forming the prediction block comprises combining a weighted first predictor that is a product of the first predictor and a first weight and a weighted second predictor that is a product of the second predictor and a second weight.

4. The video encoding method of claim 3, wherein the first weight and the second weight are calculated using a ratio of an average of pixels of the first predictor formed through intraprediction and an average of pixels of the second predictor formed through interprediction.

5. The video encoding method of claim 3, wherein an average of pixels of the first predictor formed through intraprediction is M1 and the average of pixels of the second predictor formed through interprediction is M2, the first weight is 1 and the second weight is M1/M2.

6. The video encoding method of claim 1, wherein forming the prediction block comprises forming the prediction block by performing interprediction on the current block and multiplying the formed prediction block by a weight corresponding to a ratio of an average of pixels of the first predictor formed through intraprediction and an average of pixels of the second predictor formed through interprediction.

7. The video encoding method of claim 1, further comprising comparing a first cost calculated using the prediction block, a second cost calculated from an intraprediction block predicted by performing intraprediction on the current block, and a third cost calculated from an interprediction block predicted by performing interprediction on the current block to determine a prediction block having a smallest cost to be a final prediction block for compression encoding of the current block.

8. The video encoding method of claim 1, further comprising:
generating a residue signal between the prediction block and the current block; and
performing transform, quantization, and entropy coding on the residue signal.

9. A video encoder comprising a hybrid prediction unit which forms a first predictor for an edge region of a current block to be encoded among a plurality of blocks divided from an input video through intraprediction, forms a second predictor for the remaining region of the current block through interprediction, and forms a prediction block of the current block by combining the first predictor and the second predictor.

10. The video encoder of claim 9, wherein the edge region of the current block includes pixels adjacent to previously encoded blocks.

11. The video encoder of claim 9, wherein the hybrid prediction unit forms the prediction block by combining a weighted first predictor that is a product of the first predictor and a first weight and a weighted second predictor that is a product of the second predictor and a second weight.

12. The video encoder of claim 11, wherein the first weight and the second weight are calculated using a ratio of an average of pixels of the first predictor formed through intraprediction and an average of pixels of the second predictor formed through interprediction.

13. The video encoder of claim 11, wherein an average of pixels of the first predictor formed through intraprediction is M1 and an average of pixels of the second predictor formed through interprediction is M2, the first weight is 1 and the second weight is M1/M2.

14. The video encoder of claim 9, wherein the hybrid prediction unit calculates a ratio of an average of pixels of the first predictor formed through intraprediction and an average of pixels of the second predictor formed through interprediction, forms the prediction block by performing interprediction on the current block, and multiplies the formed prediction block by a weight that corresponds the calculated ratio.

15. The video encoder of claim 9, further comprising:
an intraprediction unit which generates an intraprediction block by performing intraprediction on the current block;
an interprediction unit which generates an interprediction block by performing interprediction on the current block; and
a control unit which compares a first cost calculated using the prediction block, a second cost calculated from the intraprediction block, and a third cost calculated from the interprediction block predicted to determine a prediction block having a smallest cost to be a final prediction block for compression encoding of the current block.

16. A video decoding method comprising:
determining a prediction mode of a current block to be decoded based on prediction mode information included in a received bitstream;
if the determined prediction mode is a hybrid prediction mode in which an edge region of the current block is predicted using intraprediction and the remaining region of the current block is predicted using interprediction, forming a first predictor for the boundary region of the current block through intraprediction, forming a second predictor for the remaining region of the current block through interprediction, and forming a prediction block of the current block by combining the first predictor and the second predictor; and
decoding a video by adding a residue included in the bitstream to the prediction block.

17. The video decoding method of claim 16, wherein the edge region of the current block includes pixels adjacent to previously encoded blocks.

18. The video decoding method of claim 16, wherein the forming the prediction block comprises combining a weighted first predictor that is a product of the first predictor and a first weight and a weighted second predictor that is a product of the second predictor and a second weight.

19. The video decoding method of claim 18, wherein the first weight and the second weight are calculated using a ratio of an average of pixels of the first predictor formed through intraprediction and an average of pixels of the second predictor formed through interprediction.

20. The video decoding method of claim 18, wherein an average of pixels of the first predictor formed through intraprediction is M1 and an average of pixels of the second predictor formed through interprediction is M2, the first weight is 1 and the second weight is M1/M2.

21. A video decoder comprising a hybrid prediction unit which, if prediction mode information extracted from a received bitstream indicates a hybrid prediction mode in which an edge region of the current block is predicted using intraprediction and the remaining region of the current block is predicted using interprediction, forms a first predictor for the boundary region of the current block through intraprediction, forms a second predictor for the remaining region of the current block through interprediction, and forms a prediction block of the current block by combining the first predictor and the second predictor.

22. The video decoder of claim 21, wherein the edge region of the current block includes pixels adjacent to previously encoded blocks.

23. The video decoder of claim 21, wherein the hybrid prediction unit forms the prediction block by combining a weighted first predictor that is a product of the first predictor and a first weight and a weighted second predictor that is a product of the second predictor and a second weight.

24. The video decoder of claim 23, wherein the first weight and the second weight are calculated using a ratio of an average of pixels of the first predictor formed through intraprediction and an average of pixels of the second predictor formed through interprediction.

25. The video decoder of claim 23, wherein an average of pixels of the first predictor formed through intraprediction is M1 and an average of pixels of the second predictor formed through interprediction is M2, the first weight is 1 and the second weight is M1/M2.
